(19) United States
(12) Patent Application Publication
(10) Pub. No.: US 2008/0036206 A1
(43) Pub. Date: Feb. 14, 2008

(54) End fitting

(76) Inventor: Yan Li-guo, Fumin Town (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/494,496

(22) Filed: Jul. 28, 2006

(51) Int. Cl. F16L 21/06

(52) U.S. Cl. 285/322

(57) ABSTRACT

An end fitting has a joining insert and a pressing mechanism assembled together. The joining insert is hollow and includes a connecting end and an inserting end communicating with each other. The pressing mechanism includes a hollow retaining portion and a pressing cover. At least a holding tube extends integrally from an end of the retaining portion, and an arm portion with a plurality of branches extends from another end of the retaining portion and possesses appropriate flexibility. In practice, the arm portion of the retaining portion clamps the jointing insert, while the pressing cover restrains the arm portion. A first latch of the joining insert and a second latch of the retaining portion lock with a first embedding portion of the arm portion and a second embedding portion of the pressing cover, respectively. Hence, conduits are quickly fit to each other with eliminating need of tools.

### BACKGROUND OF THE INVENTION

1. Field of the Invention

The present invention relates to an end fitting, and particularly to an end fitting which joins at least two conduits tightly and quickly between ends of the conduits without need of auxiliary tools.

2. Related Art

Numerous conduits are employed in kitchens and bathrooms, and join each other with flexible conduits owing to limitation of operation conditions. Usually, a hard ring is retained on a tip of a flexible conduit, and connects a central conduit with a movable cap and a leakproof washer. In this way, the flexible conduit is directly fixed with an end of a conduit, as illustrated in U.S. Pat. Nos. 5,364,134 and 5,364,135.

However, since tools are necessary to mount or dismount the flexible conduits in small space, assembly of the conduits is rather cumbersome. Especially, interconnection of an undersink faucet supply line is difficult.

### SUMMARY OF THE INVENTION

Accordingly, an object of the present invention is to provide an end fitting which does not require tools for installation or removal and which is assembled simply for suiting conduit assembly in small space.

To meet the object, the end fitting of the present invention comprises a hollow joining insert and a pressing mechanism assembled together. The joining insert includes a connecting end and an inserting end communicating with each other. A first latch is formed on an outer surface of the joining insert and in the vicinity of the connecting end. At least a recessed ring is defined on the outer surface of the joining insert and in the vicinity of the inserting end for receiving leakproof rings therein. The pressing mechanism includes a hollow retaining portion and a pressing cover. At least a holding tube integrally connects with an end of the retaining portion, and an arm portion with a plurality of branches extends from another end of the retaining portion and possesses appropriate flexibility. The arm portion defines a first embedding portion at an inward edge thereof. A second latch is disposed on an outward surface of the retaining portion and adjacent to bottoms of the arm portion. The pressing cover is generally cylindrical and has inner diameter smaller than maximum outer diameter of the arm portion. A second embedding portion is provided in an end of the pressing cover for corresponding to the second latch.

In use, a first conduit is mounted on the connecting end of the joining insert, and a second conduit is mounted on the holding tube of the retaining portion. The arm portion of the retaining portion clamps the jointing insert, while the pressing cover restrains the arm portion. The first latch and the second latch lock the first embedding portion and the second embedding portion, respectively. Thus, the first conduit and the second conduit are quickly connected with each other without requirement of tools.

### BRIEF DESCRIPTION OF THE DRAWINGS

FIG. 1 is an exploded view of an end fitting according to a first embodiment of the present invention.

FIG. 2 is a partially assembled view of the end fitting of FIG. 1, wherein the end fitting is assembled on two conduits.

FIGS. 3 and 4 show cross-sectional views of sequential stages of the end fitting joining two conduits.

FIG. 5 is an exploded view of an end fitting according to a second embodiment of the present invention.

FIG. 6 schematically illustrates the end fittings of the present invention applied to join conduits.

### DESCRIPTION OF THE PREFERRED EMBODIMENTS

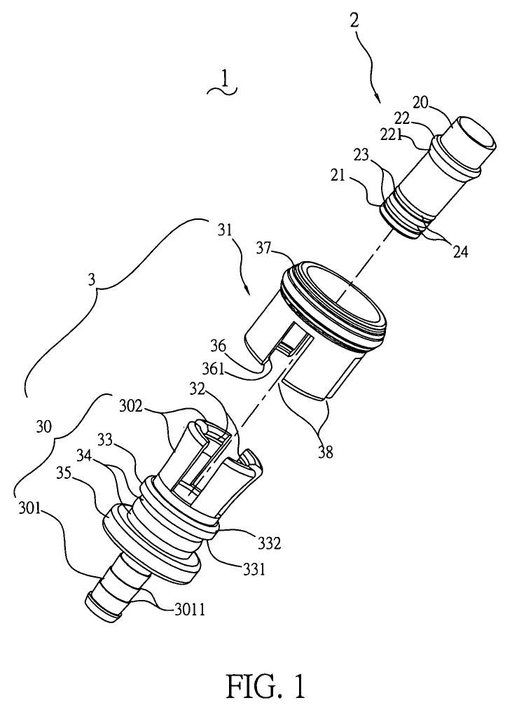

With reference to FIG. 1, an end fitting 1 in accordance with the present invention comprises a joining insert 2 and a pressing mechanism 3 assembled together. The joining insert 2 is a hollow tube, and includes a connecting end 20 and an inserting end 21 opposite to and communicating with each other. A first latch is formed on an outer surface of the joining insert 2 and in the vicinity of the connecting end 20. In one embodiment, the first latch comprises a projecting ring 22 unitarily formed on the joining insert 2. A guiding surface 221 is disposed on the projecting ring 22 and has lessened diameter toward the inserting end 21 for guiding assembly. Two recessed rings 23 are defined on the outer surface of the joining insert 2 and in the vicinity of the inserting end 21 for receiving leakproof rings 24, thereby preventing leakage of liquid in the joining insert 2 when assembled.

The pressing mechanism 3 includes a hollow retaining portion 30 and a pressing cover 31. A holding tube 301 extends integrally from an end of the retaining portion 30, and an arm portion 302 with a plurality of branches integrally extends at the same angle from another end of the retaining portion 30 and possesses appropriate flexibility. In one embodiment, the arm portion 302 comprises four branches 302. The holding tube 301 forms a plurality of ring barbs 3011 on an outward surface thereof and spaced the same distance apart from each other for reinforcing friction for reliable assembly of conduits. Each ring barb 3011 has a guiding face (not labeled) and a stop face (not labeled). The arm portion 302 defines a first embedding portion at an inward edge thereof for corresponding to the first latch. As an example, the first embedding portion includes a locking groove 32 at inward edge of the arm portion 302 for locking the projecting ring 22. A second latch is disposed on an outward surface of the retaining portion 30 and adjacent to bottoms of the arm portion 302. The second latch includes a ring flange 33 integrally formed on outward surface of the retaining portion 30. The ring flange 33 has a flat side 331 adjacent to the holding tube 301, and a cambered side 332 opposite the flat side 331. Two positioning ring grooves 34 are defined below the ring flange 33. A ring ridge 35 is provided between the holding tube 301 and the positioning ring grooves 34.

The pressing cover 31 is generally cylindrical and has an inner diameter smaller than maximum outer diameter of the arm portion 302. A second embedding portion is provided in an end of the pressing cover 31 for corresponding to the second latch, namely the ring flange 33 in this embodiment. The second embedding portion comprises a projecting lip 36 unitarily and inwardly bending at 90 degree from an end of the pressing cover 31. The projecting lip 36 has a flat abutting surface 361 for abutting against the flat side 331. A crimped rib 37 is formed at an outward surface of the pressing cover 31 for enhancing friction for manual operation. Notches 38 are defined in the pressing cover 31 for corresponding to the branches of the arm portion 302, thereby avoiding partial exposure of the arm portion 302. The projecting ring 22 latches the locking groove 32.

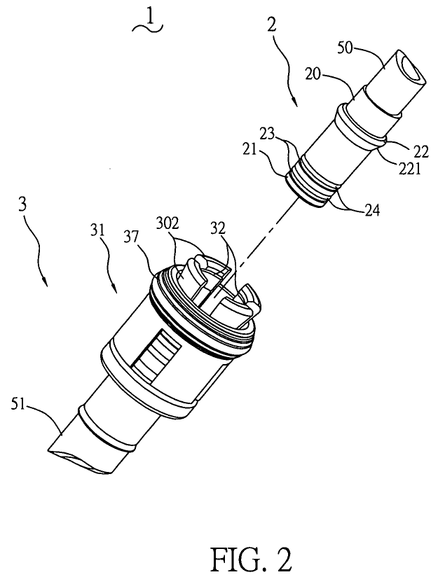

In assembly, as viewed from FIGS. 1 and 2, a first conduit 50 is mounted on the connecting end 20 of the joining insert 2, and a second conduit 51 is mounted on the holding tube 301 of the retaining portion 30. The arm portion 302 of the retaining portion 30 clamps the jointing insert 2. The pressing cover 31 restrains the arm portion 302. The projecting ring 22 latches the locking groove 32. The abutting surface 361 of the projecting lip 36 abuts against the flat side 331 of the ring flange 33. Thus, the first conduit 50 and the second conduit 51 are quickly engaged to each other without requirement of tools.

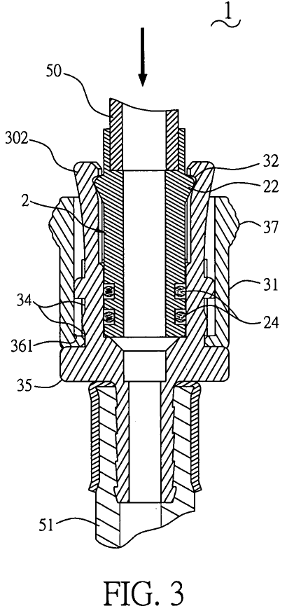

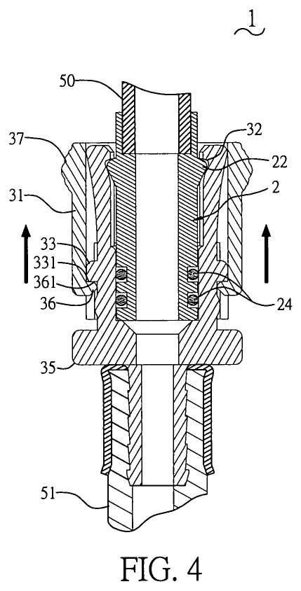

FIGS. 3 and 4 are also incorporated herein for reference. At the beginning of fitting the first conduit 50 and the second conduit 51 together, as shown in FIG. 3, the pressing cover 31 is firstly pushed to a relatively lower positioning ring groove 34, where the projecting lip 36 abuts against the ring ridge 35. Meantime the arm portion 302 is opened, and inner diameter bordered by the branches of the arm portion 302 is larger than outer diameter of the joining insert 2 so that the joining insert 2 is easily inserted into the arm portion 302. At the end of assembly, as shown in FIG. 4, the pressing cover 31 is pushed upward to a relatively upper positioning ring groove 34. The projecting lip 36 abuts against the flat side 331 of the ring flange 33. Meantime smaller diameter of the pressing cover 31 presses and limits the arm portion 302. The locking groove 32 engages projecting ring 22 tightly. The leakproof ring 24 of the joining insert 2 prevents leakage of liquid in conduits.

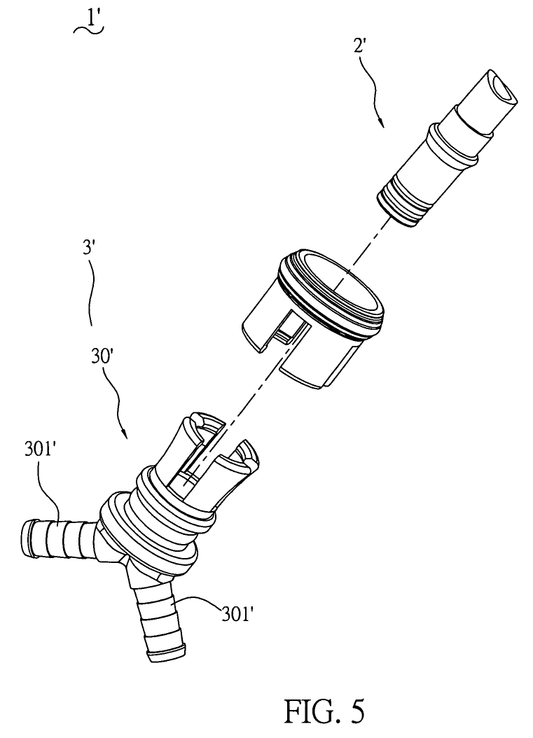

FIG. 5 is an exploded view of an end fitting in terms of a second embodiment of the present invention. Similarly, the end fitting 1′ comprises a joining insert 2′ and a pressing mechanism 3′ assembled together. The end fitting 1′ according to the second embodiment is nearly identical to the end fitting 1 according to the first embodiment except that the pressing mechanism 3′ includes a retaining portion 30′ on which two holding tubes 301′ are formed for connecting two conduits.

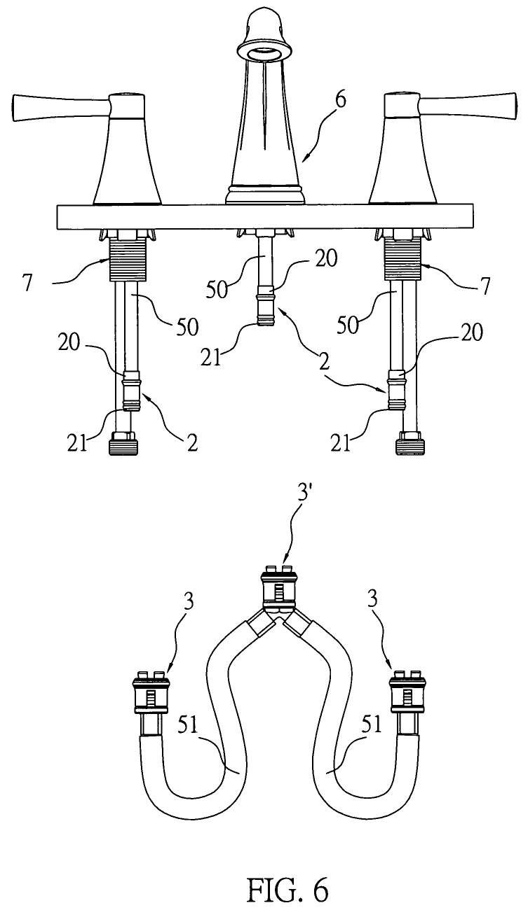

With reference to FIG. 6, the end fitting of the present invention is applied. The connecting ends 20 of the joining inserts 2 respectively connect with an outlet 6 of a faucet and a water controlling valve 7. The conduits 51 communicate the outlet 6 and the water controlling valve 7 by means of fitting of the joining inserts 2 and the pressing mechanisms 3.

It is understood that the invention may be embodied in other forms without departing from the spirit thereof. Thus, the present examples and embodiments are to be considered in all respects as illustrative and not restrictive, and the invention is not to be limited to the details given herein.

1. An end fitting, adapted for joining ends of conduits, comprising:
a hollow joining insert including a connecting end and an inserting end communicating with each other, a first latch being formed on an outer surface of the joining insert and in the vicinity of the connecting end, at least a recessed ring being defined on the outer surface of the joining insert and in the vicinity of the inserting end for receiving leakproof rings therein; and
a pressing mechanism assembled to the joining insert, and including a hollow retaining portion and a pressing cover, at least a holding tube extending integrally from an end of the retaining portion, and an arm portion with a plurality of branches extending from another end of the retaining portion and possessing appropriate flexibility, the arm portion defining a first embedding portion at an inward edge thereof, a second latch being disposed on an outward surface of the retaining portion and adjacent to bottoms of the arm portion, the pressing cover being generally cylindrical and having inner diameter smaller than maximum outer diameter of the arm portion, a second embedding portion being provided in the pressing cover for corresponding to the second latch.

2. The end fitting as claimed in claim 1, wherein the first latch comprises a projecting ring unitarily formed on the joining insert.

3. The end fitting as claimed in claim 2, wherein a guiding surface is disposed on the projecting ring and is of lessened diameter toward the inserting end for guiding assembly.

4. The end fitting as claimed in claim 3, wherein the first embedding portion comprises a locking groove at inward edge of the arm portion for locking the projecting ring.

5. The end fitting as claimed in claim 1, wherein the second latch comprises a ring flange integrally formed on outward surface of the retaining portion.

6. The end fitting as claimed in claim 5, wherein the ring flange has a flat side adjacent to the holding tube, and a cambered side opposite the flat side.

7. The end fitting as claimed in claim 6, wherein the second embedding portion comprises a projecting lip unitarily and inwardly bending at 90 degree from an end of the pressing cover, and wherein the projecting lip has a flat abutting surface for abutting against the flat side.

8. The end fitting as claimed in claim 1, wherein the holding tube forms a plurality of ring barbs on an outward surface thereof and spaced the same distance apart from each other, and wherein each ring barb has a guiding face and a stop face.

9. The end fitting as claimed in claim 1, wherein two positioning ring grooves are defined below the second latch.

10. The end fitting as claimed in claim 9, wherein a ring ridge is provided between the holding tube and the positioning ring grooves.

11. The end fitting as claimed in claim 1, wherein a crimped rib is formed at an outward surface of the pressing cover for enhancing friction for manual operation.

12. The end fitting as claimed in claim 1, wherein the arm portion has four branches integrally extending at the same angle from the retaining portion.

13. The end fitting as claimed in claim 1, wherein notches are defined in the pressing cover for corresponding to the branches of the arm portion.

14. The end fitting as claimed in claim 1, wherein one or two holding tubes extend integrally from the retaining portion.
